(19) United States
(12) Patent Application Publication
(10) Pub. No.: US 2012/0017491 A1
(43) Pub. Date: Jan. 26, 2012

(54) Gel bait for controlling crawling harmful insects

(75) Inventors: Volker GUTSMANN, Langenfeld (DE); Thomas Böcker, Leichlingen (DE); Guenther Nentwig, Leverkusen (DE)

(73) Assignee: Bayer CropScience AG, Monheim am Rhein (DE)

(21) Appl. No.: 13/186,892

(22) Filed: Jul. 20, 2011

Related U.S. Application Data
(60) Provisional application No. 61/366,199, filed on Jul. 21, 2010.

(30) Foreign Application Priority Data
Jul. 20, 2010 (EP) 10170117.5
Jan. 25, 2011 (EP) 11152000.3

(51) Int. Cl. A01M 1/20; A01N 65/00; A01P 7/04; A01N 25/34

(52) U.S. Cl. 43/131; 424/408; 424/725

(57) ABSTRACT

The invention relates to the provision of a novel gel bait for controlling harmful insects, in particular crawling insects. The invention furthermore relates to the use of such baits, to methods of preparing such baits, and to methods for controlling harmful insects.

### FIELD OF THE INVENTION

The invention relates to the provision of a novel gel bait for controlling harmful insects, in particular crawling insects. The invention furthermore relates to the use of such baits, to methods of preparing such baits, and to methods for controlling harmful insects.

### BACKGROUND OF THE INVENTION

Various methods are known for controlling insects. Among these, it is known to use baits according to the prior art. Such baits are applied where the adult insect population is most likely to reside. Baits can be provided in the form of granules. However, granules can only be applied to a horizontal construction, they cannot be applied to vertical constructions. The baits can also be provided as liquid formulations, which are also referred to as “paint-on formulations”. Such liquids are provided to the user in the form of a concentrate. The user must prepare a dilution for the use per se, followed by spraying/painting on.

WO 97/11602 describes baits for controlling insects, these baits being composed of a starting material which can be made into a gel with the aid of hydration, and of an active component selected from a group of 1-arylpyrazoles.

WO 91/07972 furthermore describes baits for controlling insects which are composed of carrageenan as the gelling agent and of specific insecticides.

To control crawling insects such as ants or cockroaches, it has already been known for some years to employ, as baits, gels which are applied in the form of dots.

The baits which are employed usually lose, in the course of storage, their attraction for the corresponding harmful insects to be controlled due to the loss of moisture or aroma substances. Moreover, many added aroma substances change their odour over a prolonged period of the storage of the product. A further disadvantage of the prior-art baits is that by adding aroma substances such as orange or banana aroma, the bait also appears attractive for other living things such as dogs, cats or children. The access to the poison bait can be prevented for example by complicated and, accordingly, expensive packaging or bait boxes.

One concept for incorporating sensitive, chemically or physically incompatible and volatile constituents is the use of capsules in which these constituents are enclosed. With capsules, one distinguishes between two types. Firstly, there are capsules with core-coat structure in which the constituent is surrounded by a wall or barrier. Secondly, there are capsules in which the constituent is distributed in a matrix of a matrix-forming material. Such capsules are also referred to as “speckles”, and they are employed in liquid detergents or detergents in the form of gels.

For example, U.S. Pat. No. 6,855,681 discloses a detergent composition which comprises a matrix-encapsulated active constituent. The matrix of the capsules contains a hydrated anionic gum, and the encapsulated active constituent is preferably a fragrance. Microcapsules are also described in DE-A 43 09 756. They have a core material which is coated with an impermeable coat of glutaraldehyde-crosslinked gelatine. The microcapsules feature a controlled release of active substance.

WO 01/30144 discloses microbeads having a hydrophilic matrix core and an adjacent second, ionically complexed layer. Alginates are mentioned as possible matrix materials. The core matrix may comprise active substances. The microbeads are added, to aqueous or solvent-based solutions, in the form of a suspension.

WO 00/32043 describes water-insoluble polymeric beads which have a polymeric matrix containing a plurality of droplets of a volatile hydrophobic compound. The compounds are preferably pheromones. Alginates are disclosed as polymeric matrix. The beads disclosed therein likewise feature a controlled release of active substance.

In conclusion, there still exists the problem of providing a storage-stable bait which is attractive to the relevant harmful insect to be controlled, in particular crawling harmful insects, but which can be applied without complicated packaging and which can also be applied to vertical constructions and/or at great height. Moreover, there still exists the problem that the prior-art baits do not show optimal efficacy when employed against larvae or nymphs.

It was therefore an object of the present invention to provide improved baits and bait formulations for controlling crawling insects, in particular cockroaches, which display a rapid onset of activity and which also show optimum activity at the point in time of application even after storage and transport. The prerequisite is that the constituents of the bait have previously neither decomposed nor volatilized. Another object was to provide a bait without complicated and therefore costly packaging, which bait is not attractive to non-target organisms. Another object was that the bait should also show a particularly good activity against larvae or nymphs.

### SUMMARY OF THE INVENTION

It has now been found that baits which, besides an insecticidal active substance, also comprise capsules which are prepared by the dripping method and which comprise one or more phagostimulants in a polymeric matrix, solve the problem of the invention.

Therefore, the present invention relates to a bait containing one or more insecticidal active substances, a bait material in the form of a gel, and water-insoluble polymeric capsules which have a diameter of from 0.1 to 5 mm, preferably 0.5 to 2 mm, especially preferably 0.8 to 1.5 mm and which have a polymer matrix which contains droplets of one or more phagostimulants.

### DESCRIPTION OF SPECIFIC EMBODIMENTS

Unless otherwise specified, the following definitions apply and the percentages are by weight.

The baits according to the invention contain at least one insecticidal active substance. Examples of suitable insecticidal active substances are:

(1) Acetylcholin esterase (AChE) inhibitors such as, for example,

carbamates, for example alanycarb, aldicarb, bendiocarb, benfuracarb, butocarboxim, butoxy-carboxime, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or
organophosphates, for example acephate, azamethiphos, azinphos (-methyl, -ethyl), cadusafos, chlorethoxyfos, chlorfenvinphos, chlormephos, chlorpyrifos (-methyl), coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isofenphos, isopropyl O-(methoxyaminothiophosphoryl)salicylate, isoxathion, malathion, mecarbam, methamidophos, methidathion, mevinphos, monocrotophos, naled, omethoate, oxydemeton-methyl, parathion (-methyl), phenthoate, phorate, phosalone, phosmet, phosphamidon, phoxim, pirimiphos (-methyl), profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-controlled chloride channel antagonists such as, for example,

organochlorines, for example chlordane and endosulfan (alpha-); or
fiproles (phenylpyrazoles), for example ethiprole, fipronil, pyrafluprole and pyriprole.

(3) Sodium channel modulators/voltage-dependent sodium channel blockers such as, for example,

pyrethroids, for example acrinathrin, allethrin (d-cis-trans, d-trans), bifenthrin, bioallethrin, bioallethrin-S-cyclopentenyl, bioresmethrin, cycloprothrin, cyfluthrin (beta-), cyhalothrin (gamma-, lambda-), cypermethrin (alpha-, beta-, theta-, zeta-), cyphenothrin [(1R)-trans isomers], deltamethrin, dimefluthrin, empenthrin [(EZ)-(1R) isomers], esfenvalerate, eto-fenprox, fenpropathrin, fenvalerate, flucythrinate, flumethrin, fluvalinate (tau-), halfenprox, imiprothrin, metofluthrin, permethrin, phenothrin [(1R)-trans isomers], prallethrin, profluthrin, pyrethrin (pyrethrum), resmethrin, RU 15525, silafluofen, tefluthrin, tetramethrin [(1R)-isomers], tralomethrin, transfluthrin and ZXI 8901; or DDT; or methoxychlor.

(4) Nicotinergic acetylcholine receptor agonists such as, for example,

neonicotinoids, for example acetamiprid, clothianidin, dinotefuran, imidacloprid, nitenpyram, thiacloprid, thiamethoxam; or nicotin.

(5) Allosteric acetylcholine receptor modulators (agonists) such as, for example,

spinosyns, for example spinetoram and spinosad.

(6) Chloride channel activators such as, for example,

avermectins/milbemycins, for example abamectin, emamectin-benzoate, lepimectin and milbemectin.

(7) Juvenile hormone analogues, for example hydroprene, kinoprene, methoprene; or fenoxycarb; pyriproxyfen.

(8) Active substances with unknown or unspecific mechanisms of action such as, for example,

fumigants, for example methyl bromide and other alkyl halides; or
chloropicrin; sulphuryl fluoride; borax; tartar emetic.

(11) Microbial disruptors of the insect gut membrane such as, for example, Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins, for example Cry1Ab, Cry1Ac, Cry1Fa, Cry2Ab, mCry3A, Cry3Ab, Cry3Bb, Cry34/35Ab1.

(12) Inhibitors of oxidative phosphorylation, ATP disruptors, such as, for example, diafenthiuron; or

organotin compounds, for example azocyclotin, cyhexatin, fenbutatin oxide; or
propargite; tetradifon.

(13) Decouplers of oxidative phosphorylation by interrupting the H-proton gradient such as, for example chlorfenapyr and DNOC.

(14) Nicotinergic acetylcholine receptor antagonists such as, for example, bensultap, cartap (-hydrochloride), thiocylam, and thiosultap (-sodium).

(15) Type 0 chitin biosynthesis inhibitors such as, for example, benzoylureas, for example bistrifluoron, chlorfluazuron, diflubenzuron, flucycloxuron, flufenoxuron, hexaflumuron, lufenuron, novaluron, noviflumuron, teflubenzuron and triflumuron.

(16) Type 1 chitin biosynthesis inhibitors such as, for example, buprofezin.

(17) Active substances which interfere with ecdysis such as, for example, cyromazine.

(18) Ecdysone agonists/disruptors such as, for example,

diacylhydrazines, for example chromafenozide, halofenozide, methoxyfenozide and tebu-fenozide.

(19) Octopaminergic agonists such as, for example, amitraz.

(20) Complex-III electron transport inhibitors such as, for example, hydramethylnon; acequinocyl; fluacrypyrim.

(21) Complex-I electron transport inhibitors, for example from the group of METI acaricides, for example fenazaquin, fenpyroximate, pyrimidifen, pyridaben, tebufenpyrad, tolfenpyrad; or rotenone (Derris).

(22) Voltage-dependent sodium channel blockers, for example indoxacarb; metaflumizone.

(23) Acetyl-CoA-carboxylase inhibitors such as, for example, tetronic acid derivatives, for example spirodiclofen and spiromesifen; or tetramic acid derivatives, for example spirotetramat.

(24) Complex-IV electron transport inhibitors such as, for example, phosphines, for example aluminium phosphide, calcium phosphide, phosphine, zinc phosphide; or cyanide.

(25) Complex-II electron transport inhibitors such as, for example, cyenopyrafen.

(28) Ryanodine receptor effectors such as, for example, diamides, for example chlorantraniliprole (rynaxypyr), cyantraniliprole (cyazypyr) and flubendiamide.

Other active substances with unknown mechanism of action such as, for example, azadirachtin, amidoflumet, benzoximate, bifenazate, quinomethionate, cryolite, cyflumetofen, dicofol, flufenerim, pyridalyl and pyrifluquinazon; or the following known active compounds

4-{[(6-bromopyrid-3-yl)methyl](2-fluoroethyl)amino}furan-2(5H)-one (known from WO 2007/115644), 4-{[(6-fluoropyrid-3-yl)methyl] (2,2-difluoroethyl)amino}furan-2(5H)-one (known from WO 2007/115644), 4-{[(2-chloro-1,3-thiazol-5-yl)methyl](2-fluoroethyl)amino}furan-2(5H)-one (known from WO 2007/115644), 4-{[(6-chloropyrid-3-yl)methyl](2-fluoroethyl)amino}furan-2(5H)-one (known from WO 2007/115644), 4-{[(6-chloropyrid-3-yl)methyl](2,2-difluoroethyl)amino}furan-2(5H)-one (known from WO 2007/115644), 4-{[(6-chloro-5-fluoropyrid-3-yl)methyl](methyl)amino}furan-2(5H)-one (known from WO 2007/115643), 4-{[(5,6-dichloropyrid-3-yl)methyl](2-fluoroethyl)amino}furan-2(5H)-one (known from WO 2007/115646), 4-{[(6-chloro-5-fluoropyrid-3-yl)methyl](cyclopropyl)amino}furan-2(5H)-one (known from WO 2007/115643), 4-{[(6-chloropyrid-3-yl)methyl] (cyclopropyl)amino}furan-2(5H)-one (known from EP-A-0 539 588), 4-{[(6-chloropyrid-3-yl)methyl](methyl)amino}furan-2(5H)-one (known from EP-A-0 539 588), [(6-chloropyridin-3-yl)methyl] (methyl)oxido-λ⁴-sulphanylidenecyanamide (known from WO 2007/149134), [1-(6-chloropyridin-3-yl)ethyl](methyl)oxido-λ⁴-sulphanylidenecyanamide (known from WO 2007/149134) and its diastereomers (A) and (B)

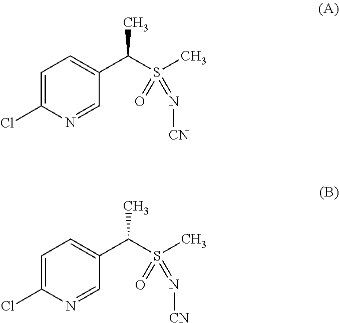

(also known from WO 2007/149134), [(6-trifluoromethylpyridin-3-yl)methyl](methyl)oxido-λ⁴-sulphanylidenecyanamide (known from WO 2007/095229), sulfoxaflor
(also known from WO 2007/149134), 11-(4-chloro-2,6-dimethylphenyl)-12-hydroxy-1,4-dioxa-9-azadispiro[4.2.4.2]tetradec-11-en-10-one (known from WO 2006/089633), 3-(4′-fluor-2,4-dimethylbiphenyl-3-yl)-4-hydroxy-8-oxa-1-azaspiro[4.5]dec-3-en-2-one (known from WO 2008/067911) and 1-{2,4-dimethyl-5-[(2,2,2-trifluoroethyl)sulphinyl]phenyl}-3-(trifluoromethyl)-1H-1,2,4-triazole (known from WO 1999/55668).

The insecticidal active substance is preferably selected from the group comprising nicotinergic acetylcholine receptor agonists, fiprols, allosteric acetylcholine receptor modulators, voltage-dependent sodium channel blockers and chloride channel activators.

Especially preferred are imidacloprid, clothianidin, fipronil, spinosad, indoxacarb and abamectin.

Imidacloprid is very especially preferred. In a further especially preferred embodiment, the bait according to the invention contains fipronil. It is likewise especially preferred that the bait according to the invention contains clothianidin.

The baits according to the invention contain feedants, phagostimulants and, if appropriate, attractants. Feedants refer to constituents which serve for the insects' feed uptake. Phagostimulants refer to all constituents which, in insects, enhance or prolong a feeding process. Attractants refer to all substances which are capable of attracting insects over a distance. It is possible to employ mixtures of all three constituents. However, it is preferred to exclusively employ feedants and phagostimulants.

Examples of suitable foods/feedants employed in baits are water, cereal powder such as, for example, wheat powder, maize powder, rice powder, rice bran and the like, starches such as, for example, potato starch, corn starch and the like, various sugars such as, for example, sucrose, maltose, arabinose, galactose, sorbitose, dextrose, fructose, sorbitol, corn syrup, maple syrup, molasses, coca-cola syrup, various types of invert sugar (Invertix), molasses honey and the like, and glycerol and the like. Proteins such as, for example, meat, meat extract and milk powder, fish meal, fish extracts, or seafood, seafood extracts, insects, insect extracts or yeast, yeast extract and the like. Others which are suitable as bait materials are fats and oils such as, for example, vegetable oils, for example made from maize, olives, caraway, peanuts, sesame oil, soybeans, sunflowers, animal fats and oils, and oils obtained from fish, and the like. These bait materials can be used alone or as a mixture of one or more substances in any ratio. Especially preferred are those feedants such as, for example, water, simple or complex sugars, meat extracts, animal fats and oils.

Examples of suitable phagostimulants employed in baits are, for example, extracts from meat, fish or insects. Others which are suitable for phagostimulation are certain natural or synthetic aroma substances such as, for example, meat aromas, fish aromas, seafood aromas, onion aroma, milk aroma, butter aroma, cheese aromas, fruit aromas such as, for example, apple, apricot, banana, blackberry, cherry, currant, gooseberry, grapefruit, raspberry or strawberry (pure, syrup or extract). Especially preferred phagostimulants are, for example, extracts from meat, fish or insects and fruit aromas. A fruit aroma substance which is very especially suitable is banana aroma.

Pheromones have as yet not been used commercially in baits against crawling insects, in particular cockroaches. The following examples of attractants which can be employed in insect bait gels may be mentioned for the sake of completeness: aggregation pheromones of the German cockroach (faecal extracts, carboxylic acids, blattellastanoside A and B, dimethylamino-(1-)2-methyl-2-propanol, dimethylamine and its hydrochloride), sexual pheromones of the German cockroach (dimethyl-(3,11-)-2-nonacosanone, hydroxy-(29-)-3,11-dimethyl-2-nonacosanone, oxo-(29-)3,11-dimethyl-2-nonacosanone, 3,11-dimethyl-2-heptacosanone, gentisyl quinone isovalerate=blattellaquinone), sexual pheromones of the American cockroach (germacratriene=periplanone A, germacradiene=periplanone B and their derivatives) and mimetics (for example (+)-bornyl acetate, fenchyl acetate, germacrene D, verbenzyl acetate, verbenzyl propionate), sexual pheromones of the brown-banded cockroach (dimethylheptanyl-5-(2′,4′)-3-methyl-2H-pyran-2-one=supellapyrone, methyl-(3-),5(2,4-dimethylheptanyl)-alpha-pyrone).

In a preferred embodiment of the bait according to the invention, the bait material contains one or more bait feedants and, if appropriate, one or more phagostimulants.

In an alternative embodiment of the bait according to the invention, the bait material contains at least one bait feedant and at least one phagosimulant.

The capsules which the baits according to the invention contain will preferably, besides the polymeric matrix, also include phagostimulants and, if appropriate, attractants or colourants which are embedded in this matrix. The capsules which the baits according to the invention contain will, besides the polymeric matrix, especially preferably also include one or more phagostimulants and colourant.

The dripping method is employed to prepare the capsules which the baits according to the invention contain. The monodisperse spherical capsules are obtained by dripping an aqueous mixture containing phagostimulants and water-soluble crosslinkable polymer and, if appropriate, colourant, followed by crosslinking of the polymer.

The amount of crosslinkable polymer in the aqueous matrix solution preferably amounts to between 0.01% by weight and 5% by weight, especially preferably to between 0.1% by weight and 3% by weight and particularly preferably to between 0.5% by weight and 2% by weight.

The amount of phagostimulants employed in the aqueous matrix solution amounts to between 0.01 and 50% by weight, preferably to between 0.05 and 10% by weight and especially preferably to between 0.1 and 5% by weight.

The amount of colourant employed in the aqueous matrix solution amounts to between 0.001 and 5% by weight, preferably to between 0.05 and 1% by weight and especially preferably to between 0.08 and 0.1% by weight.

The crosslinkable polymer is water-soluble so that it can be used to prepare the aqueous solutions with at least the abovementioned upper concentration limits. Another crosslinkable polymer is preferably an ionotropically crosslinkable polymer. The latter is selected in particular from the group comprising carrageenan, alginate and gellan gum and their mixtures, and sodium alginate is especially preferably employed as the matrix-forming crosslinkable polymer.

By using the dripping method, it is possible to ensure, in a simple manner, that the particles are spherical, in other words largely round, in particular that its diameter in all other spatial dimensions is not more than 15%, preferably not more than 10% and especially preferably not more than 5% less than its diameter along the largest spatial dimension.

It is preferred to select the matrix-forming crosslinkable polymer from among a material from the group comprising carrageenan, alginate and gellan gum and their mixtures, with sodium alginate being especially preferred.

Alginate is a natural occurring salt of alginic acid which is found in brown algae (Phaeophycea) as a cell wall constituent. Alginates are acidic, carboxyl-containing polysaccharides with a relative molecular weight MR of approximately 200,000, composed of D-mannuronic acid and L-guluronic acid in different ratios, which are linked via 1,4-glycosidic bonds. The sodium, potassium, ammonium and magnesium alginates are water-soluble. The viscosity of alginate solutions depends, inter alia, on the molar mass and on the counterion. Calcium alginates, for example, will in certain weight ratios form thermoirreversible gels. Sodium alginates give highly viscous solutions with water and can be crosslinked by interaction with di- or trivalent metal ions, such as Ca²⁺. In this way, constituents, which are also present in the aqueous sodium alginate solution, are enclosed in an alginate matrix. It is preferred to employ a CaCl₂ solution for the crosslinking process.

Carrageenan is an extract from the red algae belonging to the Floredeae (Chondrus crispus and Gigartina stellata). Carrageenan crosslinks in the presence of K⁺ ions or Ca²⁺ ions.

Gellan gum is an unbranched anionic microbial heteroexopolysaccharide with a tetrasaccharide repeat unit composed of the monomers glucose, glucuronic acid and rhamnose, where approximately every repeat unit is esterified with an L-glycerate and every other repeat unit with an acetate. Gellan gum crosslinks in the presence of K⁺ ions, Na⁺ ions, Ca²⁺ ions or Mg²⁺ ions. Preferred material, for the matrix, among those mentioned above is alginate.

These materials can be crosslinked particularly well with cations to give crosslinked insoluble gels. By dripping solutions of these materials into cation-containing solutions, it is possible to prepare, in a simple manner, essentially spherical capsules which additionally contain the solution constituents inside them. If the solution of the crosslinking materials includes yet further constituents, in the present case attractants, the latter are, after the crosslinking process, surrounded by the capsule material and thereby protected. It is possible to remove, at least to some extent, the solvent, in particular water, from the inside of the capsule by drying. Complete removal is usually not necessary and in particular not preferred when it is intended to incorporate the capsules into a gel-like bait material which already likewise contains the solvent in question, in particular water, since in such a case the solvent equilibrium between the inside of the capsule and the outer continuous liquid phase which surrounds the capsule will establish more rapidly.

It is preferred first of all to fully dissolve the crosslinkable polymer in water and then to add the phagostimulant and, if appropriate the colourant, followed by mixing. This solution is referred to as the dripping solution. The term hardening bath refers to an aqueous cation-containing solution. Dripping is then performed by transferring the dripping solution into a feed vessel and the hardening bath into a recipient vessel. The dripping solution is pumped from the feed vessel into the drip head. The nozzle, and thus the fluid stream, are oscillated by a vibrating unit, preferably a membrane. This causes the fluid stream to disintegrate into individual drops of equal size. The drops generated fall into the hardening bath, and the drops which enter crosslink to give capsules. After their preparation, the capsules thus obtained are washed with fully-demineralized water and packaged.

Within the framework of the production process, the capsules may have any shape, but they are preferably at least approximately spherical. Moreover, the dripping process can ensure readily that they are monodisperse, in other words all capsules are essentially the same size, since constant dripping conditions from the same dripping fluid will give identical drops.

It may be desirable for aesthetic reasons that the capsules be coloured. To this end, the capsule may contain one or more colours such as pigment or colourant. Preferably, this will be obtained from the aqueous matrix solution, which, to this end, contains colours, in particular colours that are used in the food or textile industry. An especially preferred pigment is Indanthren Blue T-BC.

The bait according to the invention is present in the form of a gel. For the purposes of the present invention, gels are colloids in which the dispersed phase has combined with the continuous phase to give a jelly-like product with the following properties: dynamic viscosity of between 4000 and 100,000 mPas, preferably 4000 to 10,000 mPas (20° C., rotary viscometer, shear rate 10/s).

The bait according to the invention can be prepared for example in such a manner that the gelling agent and water are mixed, the mixture is liquefied by heating, the insecticidal active substance, the polymeric capsules, the bait material or, if necessary, other adjuvants are added, and the mixture is solidified by cooling. The products thus obtained can be formulated in any desired shape by bringing them into a suitable shape during the cooling and solidification process. Furthermore, they can be brought into any shape after solidification using methods including cutting, comminuting and the like.

In a preferred variant, the bait according to the invention is prepared in such a way that the gelling agent and water are mixed, the insecticidal active substance, the bait material or, if necessary, other adjuvants are added, and the mixture is subsequently solidified by changing the pH. The polymeric capsules are subsequently stirred into the gel.

Suitable gelling agents are any among a multiplicity of hydrophilic substances which are used for forming a gel by increasing the viscosity and the yield point of fluid mixtures. The following may be mentioned by way of example as gelling agents according to the invention: starches, gellan gum, carrageenan gum, agar-agar, casein, gelatin, carob gum, anthan gum, jelutong gum, polysaccharide gums, phycocolloids, polyacrylate polymer, semisynthetic cellulose derivatives (carboxymethyl-cellulose and the like), polyvinyl alcohol, carboxyvinylates, bentonites, silicates and colloidal silica. These gelling agents can be used alone or as a mixture of two or more agents in any ratio. Preferred gelling agents are xanthan gums and polyacrylate polymers. Especially preferred gelling agents are Rhodopol G and Carbopol EZ-2.

If appropriate, the baits according to the invention can contain further adjuvants such as stabilizers, repellants, colorants or antiseptics.

Examples of stabilizers are a calcium salt, such as calcium lactate, calcium chloride and the like. Examples of suitable repellants are hot or bitter substances such as for example cayenne pepper powder, denatorium benzoate and the like. An especially preferred repellant is denatorium benzoate. Examples of antiseptics are sorbic acid, sorbates, benzoic acid, benzoate, paraoxybenzoic ester, methylisothiazolinone, benzoisothiazolinone, chloromethylisothiazolinone and the like. Especially preferred antiseptics are sorbic acid, sodium benzoate, methylisothiazolinone, benzoisothiazolinone and chloromethylisothiazolinone.

The content of insecticidal active substances in the baits according to the invention is generally between 1×10⁻⁵ and 10% by weight, the content of gelling agent in general between 0.1 and 5% by weight, preferably between 0.5 to 2% by weight, the content of bait materials in general between 10 and 70% by weight and the content of polymeric capsules between 1 and 10% by weight and that of other adjuvants between 0.1 and 25% by weight.

The baits according to the invention can be used for controlling various crawling insects by placing them at locations where harmful insects live or which they pass.

Among the harmful insects which can be controlled, one should mention not only insects such as the German cockroach (Blattella germanica), the oriental cockroach (Blatta orientalis), the American cockroach (Periplaneta americana), the brown-banded cockroach (Supella longipalpa), but also flies such as the housefly (Musca domestica) and ants such as, for example, the pavement ant (Tetramorium caespitum), the black garden ant (Lasius niger), the Pharaoh ant (Monomorium pharanois), the Argentine ant (Linepithema humile), the dark-headed ant (Tapinoma melanocephalum). The baits according to the invention are preferably employed for controlling cockroaches, that is insects from the order Blattariae, in particular the family Blattellidae, preferably the species Blattella germanica or the family Blattidae, preferably the species Blatta orientalis and Periplaneta americana, but also against other cockroache species, but very especially preferably against Blattella germanica.

It is especially preferred to use the bait according to the invention for controlling crawling insects, preferably from the order Blattariae, which are in the larval or nymphal stage.

Doses of insecticidal active substances used in applications in domestic premises, for example for controlling cockroaches, and for external applications, for example for controlling ants or Armadillidia, are for example between 5 and 500 mg per m². The doses of insecticidal active substances in the baits according to the invention are generally between 1×10⁻⁵ and 10% by weight.

However, the bait compositions according to the invention are also active against species such as, for example, harmful species from the order of the
Zygentoma, for example Lepisma saccharina;
Orthoptera, for example Acheta domesticus, Gryllotalpa spp.,
Dermaptera, for example Forficula auricularia;
Crustacea, for example Porcellio scaber

The present invention is illustrated in greater detail hereinbelow with reference to preferred use examples, to which, however, it is not limited.

### EXAMPLES

TABLE 1
Number of the contacts of a cockroach population which leads to
feeding within 10 minutes. The cockroaches can choose freely between
standard bait gel with encapsulated aroma substance and free aroma
substance

Number of feeding contacts
with standard bait gel with

| | unencapsulated | encapsulated |
|---|---|---|
| Minute | aroma | aroma |
| 0-1 | | |
| 1-2 | | 1 |
| 2-3 | 1 | |
| 3-4 | | 1 |
| 4-5 | 1 | |
| 5-6 | 1 | 2 |
| 6-7 | | 2 |
| 7-8 | 2 | 3 |
| 8-9 | | 1 |
| 9-10 | 1 | 1 |
| Total | 6 | 11 |

TABLE 2
Total number of dead cockroaches (adults) after application of the
specified baits after the specified period (d = days, w = weeks)

| Formulation | 1 d | 2 d | 3 d | 6 d | 2 w |
|---|---|---|---|---|---|
| Maxforce ® White IC standard | 1 | 1 | 3 | 12 | 26 |
| Maxforce ® White IC (formula with 5% | 3 | 3 | 11 | 32 | 66 |
| alginate capsules + 0.20% banana aroma) | | | | | |
| Control | 0 | 0 | 0 | 0 | 0 |

Maxforce ® White IC: based on 2.15% by weight imidacloprid

TABLE 3
Total number of dead cockroaches (larval stages) after application
of the specified baits after the specified period.

| Formulation | 1 d | 2 d | 3 d | 6 d | 2 w |
|---|---|---|---|---|---|
| Maxforce ® White IC standard | 0 | 12 | 12 | 30 | 60 |
| Maxforce ® White IC (formula with 5% | 17 | 42 | 51 | 98 | 167 |
| alginate capsules + 0.20% banana aroma) | | | | | |
| Control | 1 | 1 | 1 | 1 | 1 |

TABLE 4
Improved uptake of (feeding on) the product according to the invention

| | Amount of consumed |
|---|---|
| Formulation | bait [mg] |
| Maxforce ® White IC standard | 61 |
| Maxforce ® White IC (formula with 5% alginate | 244 |
| capsules + 0.20% banana aroma) | |

TABLE 5
Ratio of larval stages to adults. A factor <1 means more larvae
than adults. The analysis of the trap contents demonstrates that
the ratio in the product according to the invention is reversed,
that is to say more adults than larvae are trapped.

| | Ratio of larvae to adults | | | | |
|---|---|---|---|---|---|
| | | 3 days | 7 days | 14 days | 28 days |
| | Prior to | after | after | after | after |
| | treatment | treatment | treatment | treatment | treatment |
| Maxforce ® | 1.5 | 2.5 | 2.0 | 3.9 | 4.3 |
| White IC | | | | | |
| Maxforce ® | 1.7 | 0.4 | 0.7 | 0.2 | 0.2 |
| White IC | | | | | |
| (with 5% | | | | | |
| alginate | | | | | |
| capsules + | | | | | |
| 0.20% | | | | | |
| banana | | | | | |
| aroma) | | | | | |
| Reference | 1.4 | 1.2 | 2.1 | 2.3 | 3.3 |
| product* | | | | | |
| Untreated | 1.5 | 1.6 | 1.6 | 1.5 | 1.7 |
| control | | | | | |

Maxforce ® gel containing 2% hydramethylnon

TABLE 6
(Blattella germanica): Comparison of products according
to the invention which contain, as insecticidal active
substance, either 2.15% imidaclopid or 1% clothianidin.

| | % Mortality | | | | | | | |
|---|---|---|---|---|---|---|---|---|
| | Adults | | | | Nymphs | | | |
| Formulation | 1 d | 2 d | 3 d | 6 d | 1 d | 2 d | 3 d | 6 d |
| Maxforce ® White IC formula | 68 | 76 | 92 | 92 | 38 | 56 | 62 | 78 |
| 2.15% imidacloprid + 5% | | | | | | | | |
| alginate capsules with 0.2% | | | | | | | | |
| banana aroma | | | | | | | | |
| Maxforce ® White IC formula | 92 | 96 | 98 | 98 | 74 | 74 | 98 | 100 |
| 1% clothianidin + 5% | | | | | | | | |
| alginate capsules with 0.2% | | | | | | | | |
| banana aroma | | | | | | | | |
| Control | 0 | 0 | 0 | 0 | 0 | 0 | 0 | 0 |

The use of clothianidin brings about a further increase in the efficacy, in this case for the German cockroach B. germanica.

TABLE 7
(Blatta orientalis): Comparison of products according
to the invention which contain, as insecticidal active substance,
either 2.15% imidaclopid or 1% clothianidin.

| | % Mortality | | | | | | | |
|---|---|---|---|---|---|---|---|---|
| | Adults | | | | Nymphs | | | |
| Formulation | 1 d | 2 d | 3 d | 6 d | 1 d | 2 d | 3 d | 6 d |
| Maxforce ® White IC formula | 64 | 56 | 76 | 86 | 48 | 54 | 62 | 74 |
| 2.15% imidacloprid + 5% alginate | | | | | | | | |
| capsules with 0.2% banana aroma | | | | | | | | |
| Maxforce ® White IC formula | 76 | 74 | 90 | 96 | 40 | 62 | 72 | 86 |
| 1% clothianidin + 5% alginate | | | | | | | | |
| capsules with 0.2% banana aroma | | | | | | | | |
| Control | 0 | 0 | 0 | 0 | 0 | 10 | 30 | 30 |

The use of clothianidin brings about a further increase in the efficacy, in this case for the oriental cockroach B. orientalis.

TABLE 8
(Periplaneta americana): Comparison of products according
to the invention which contain, as insecticidal active substance,
either 2.15% imidaclopid or 1% clothianidin.

| | % Mortality | | | | | | | |
|---|---|---|---|---|---|---|---|---|
| | Adults | | | | Nymphs | | | |
| Formulation | 1 d | 2 d | 3 d | 6 d | 1 d | 2 d | 3 d | 6 d |
| Maxforce ® White IC formula | 34 | 46 | 46 | 40 | 16 | 48 | 48 | 44 |
| 2.15% imidacloprid + 5% alginate | | | | | | | | |
| capsules with 0.2% banana aroma | | | | | | | | |
| Maxforce White IC formula | 66 | 86 | 92 | 98 | 12 | 58 | 64 | 72 |
| 1% clothianidin + 5% alginate | | | | | | | | |
| capsules with 0.2% banana aroma | | | | | | | | |
| Control | 0 | 0 | 0 | 0 | 0 | 10 | 10 | 10 |

The use of clothianidin brings about an obvious increase in the efficacy, in this case for the American cockroach P. americana.

1. A bait composition comprising one or more insecticidal active substances, a bait material, in the form of a gel, and water-insoluble polymeric capsules which have a diameter of from 0.1 to 5 mm, wherein the water-insoluble polymeric capsules further comprise a polymer matrix comprising droplets of one or more phagostimulants.

2. The bait composition according to claim 1 wherein the diameter is from 0.5 to 2 mm.

3. The bait composition according to claim 1 wherein the one or more insecticidal active substances is selected from the group consisting of imidacloprid, clothianidin, fipronil, spinosad, indoxacarb and abamectin.

4. The bait composition according to claim 3 wherein the one or more insecticidal active substances is imidacloprid.

5. The bait composition according to claim 3 wherein the one or more insecticidal active substances is fipronil.

6. The bait composition according to claim 3 wherein the one or more insecticidal active substances is clothianidin.

7. The bait composition according to claim 1 wherein the bait material comprises one or more bait feedants.

8. The bait composition according to claim 1 wherein the bait material comprises at least one bait feedant and the one or more phagostimulants.

9. The bait composition according to claim 1 wherein the capsules comprise the one or more phagostimulants.

10. The bait composition according to claim 1 wherein the capsules comprise the one or more phagostimulants and a colourant.

11. The bait composition according to claim 9 wherein the one or more phagostimulants is a banana aroma.

12-14. (canceled)

15. The bait composition according to claim 10 wherein the one or more phagostimulants is a banana aroma.

16. The bait composition according to claim 9 wherein the capsule further comprises an attractant.

17. The bait composition according to claim 9 wherein the capsule further comprises a colourant.

18. A method of controlling crawling insects comprising placing the bait composition according to claim 1 at locations where said insects live or where they pass.

19. The method according to claim 18 wherein said crawling insects are in a larval stage or a nymphal stage.

20. The method according to claim 18 wherein said crawling insects are from the order Blattariae.
